(19) United States
(12) Patent Application Publication
(10) Pub. No.: US 2015/0248673 A1
(43) Pub. Date: Sep. 3, 2015

(54) METHODS AND APPARATUS FOR A TOKEN MANAGEMENT SYSTEM FOR TRANSACTIONS

(71) Applicants: Sayed Abbas Almohri, Bayan (KW); Hussain Almohri, Bayan (KW)

(72) Inventors: Sayed Abbas Almohri, Bayan (KW); Hussain Almohri, Bayan (KW)

(21) Appl. No.: 14/194,163

(22) Filed: Feb. 28, 2014

(51) Int. Cl. G06Q 20/38

(52) U.S. Cl. CPC G06Q 20/3825

(57) ABSTRACT

A non-transitory processor-readable medium stores code representing instructions to be executed by a processor. The code includes code to cause the processor to receive, from a first compute device, a request for a token associated with a transaction between the first compute device and a second compute device. The code also defines an attribute value associated with the first compute device in response to receiving the request. The code further selects a token from a set of predefined tokens at least based on the attribute value associated with the first compute device and the attribute value associated with the second compute device. The code further sends a signal representing the token to the first compute device such that an association between the first compute device and the second compute device can be defined based on the token.

### BACKGROUND

Some embodiments described herein relate generally to a token management system for transactions. For example, such a token management system can provide tokens to a mobile communication device of a user for financial transactions.

Payment tokens are used in known electronic transactions between two or more parties (e.g., between payers and payees in mobile communication transactions). A payment token represents an arithmetic link between a payer and a payee to define a payment transaction between the two parties to define an electronic transaction that replaces physical interactions between the parties involved in a financial transaction. The involved parties typically include a payee that wishes to charge and collect a certain amount of payment from a payer(s), for example, for a service provided to the payers by the payee.

The payment tokens are typically defined and stored in a storage device; when a request for a token is received from a transaction system, the list of payment tokens in the storage device is searched for an unused payment token to be associated with the transaction. The search, however, can be a time consuming process and can cause delay in the transaction.

Therefore, a need exists to overcome the shortcomings of the known methods for token definition.

### SUMMARY

In some embodiments, a non-transitory processor-readable medium stores code representing instructions to be executed by a processor. The code includes code to cause the processor to receive, from a first compute device, a request for a token associated with a transaction between the first compute device and a second compute device. The code also includes code to define an attribute value associated with the first compute device in response to receiving the request. The code further includes code to select a token from a set of predefined tokens at least based on the attribute value associated with the first compute device. The code further includes code to send a signal representing the token to the first compute device such that an association between the first compute device and the second compute device can be defined based on the token.

### BRIEF DESCRIPTION OF THE DRAWINGS

FIG. 1 is a schematic block diagram of a computer system providing token management, according to an embodiment.

FIG. 2 is a schematic illustration of a transaction management system, according to an embodiment.

FIG. 3 is a flowchart of a process for token definition, according to an embodiment.

FIG. 4 is a flowchart of a process for token definition based on token reservation, according to an embodiment.

### DETAILED DESCRIPTION

Some known online transaction systems such as mobile transaction systems typically define location-based tokens based on the location of electronic devices (e.g., mobile devices) involved in a transaction, to enhance transaction security. In such systems, a change in the location of a mobile communication device can prompt the transaction system to authenticate the mobile device before the transaction between the mobile communication device and a service provider device is allowed. The tokens, however, are typically predefined and stored in advance in a pool of tokens and are associated with the parties involved in the transaction such as, for example, the mobile communication devices and the service provider devices, when requested. For example, during a mobile payment transaction from a payer (e.g., a user using a mobile communication device) to a payee (e.g., a service provider using a service provider device), a token request can be sent from the payer device or from a transaction agent associated with the payer to the transaction system. The transaction system can select an unused token from a pool of predefined tokens to be assigned to the transaction. The high volume of tokens, however, may cause the token selection process to be slow and time consuming, and may slow the transaction.

In contrast, in some embodiments described herein, tokens can be categorized into sets of tokens such as, for example, reserved and unreserved tokens based on various attributes associated with transaction parties. Token categorization enables the transaction management system to, for each transaction between two or more parties, search a set of tokens reserved based on specific attributes of the parties involved in the transaction.

In some embodiments, a non-transitory processor-readable medium stores code representing instructions to be executed by a processor. The code includes code to cause the processor to receive, from a first compute device, a request for a token associated with a transaction between the first compute device and a second compute device. The code also includes code to define an attribute value associated with the first compute device in response to receiving the request. The code further includes code to select a token from a set of predefined tokens at least based on the attribute value associated with the first compute device. The code further includes code to send a signal representing the token to the first compute device such that an association between the first compute device and the second compute device can be defined based on the token.

In some embodiments, a non-transitory processor-readable medium storing code representing instructions to be executed by a processor. The code includes code to cause the processor to receive, from a first compute device from a set of compute devices, a request for a token associated with a transaction between the first compute device and a second compute device from the set of compute devices. The set of compute devices is associated with a set of attribute values and a set of predefined tokens. The set of predefined tokens has a subset of predefined tokens defined as reserved tokens based on the set of attribute values. The remainder of tokens from the set of predefined tokens as unreserved tokens. The code also includes code to cause the processor to select a token from the reserved tokens, when the attribute values associated with the first compute device are included in the set of attribute values associated with the reserved tokens. The code further includes code to cause the processor to select a token from the unreserved tokens, when the attribute values associated with the first compute device are not included in the set of attribute values associated with the reserved tokens. The code further includes code to cause the processor to send a signal representing the token to the first compute device such that an association between the first compute device and the second compute device can be defined based on the token.

In some embodiments, a non-transitory processor-readable medium storing code representing instructions to be executed by a processor. The code includes code to cause the processor to receive, from a first compute device from a set of compute devices, a request for a token associated with a transaction between the first compute device and a second compute device from the set of compute devices. Each compute device from the set of compute devices is associated with a region value from a set of region values. Each region value from the set of region values is associated with a flag value of targeted or untargeted. The set of compute devices is associated with a set of predefined tokens. The set of predefined tokens has a subset of predefined tokens defined as reserved tokens based on the set of region values. The remainder of tokens from the set of predefined tokens defined as unreserved tokens. The code also includes code to cause the processor to select a token from the reserved tokens when the flag value for the region value associated with the first compute device is targeted, and a token from the unreserved tokens when the flag value for the region value associated with the first compute device is untargeted, to produce a selected token. The code also includes code to cause the processor to send a signal representing the selected token to the first compute device such that an association between the first compute device and the second compute device can be defined based on the token.

As used herein, “user” or “payer” can be a person, a module, a mobile communication device, an application, or any entity that accesses a network location. In some of the embodiments discussed, a user or payer refers to a person using a compute device via one or more user interfaces. Additionally/alternatively, a user or payer can refer to a mobile communication device, a module of a device, or an application such as, for example, a bidding application, an online shopping application, an advertisement engine, a browser, etc., that can provide purchase opportunities (e.g., from one or more online stores) that can be managed by the described methods and system.

As used herein, the singular forms “a,” “an” and “the” include plural referents unless the context clearly dictates otherwise. Thus, for example, the term “a “region” is intended to mean a single region or multiple regions (e.g., regions with similar campaign parameters or similar impact estimates, etc.).

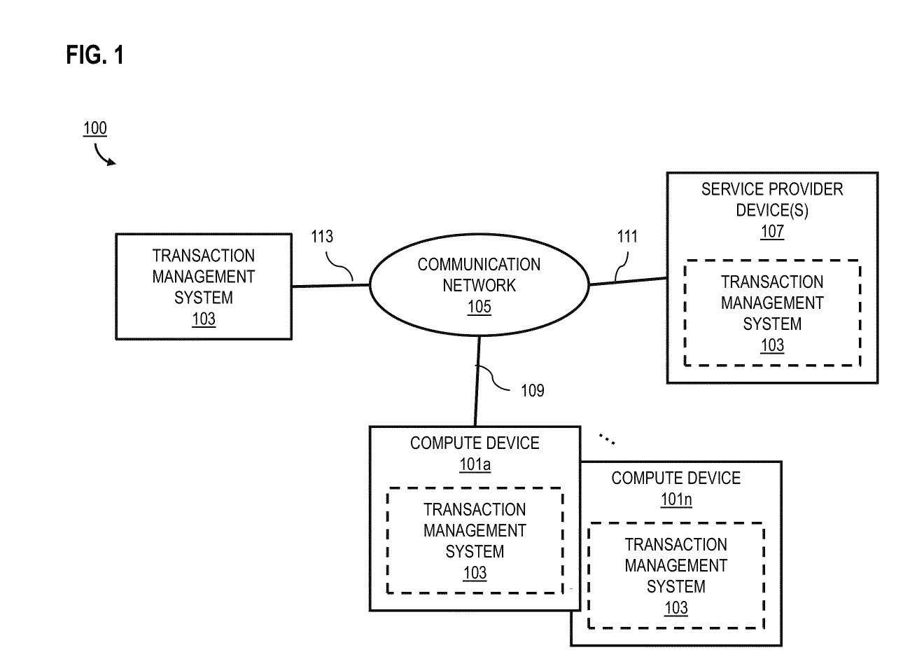

FIG. 1 is a schematic block diagram of a computer network system providing token management, according to an embodiment. The computer network system 100 includes at least one compute device(s) 101a-101n, each of which can have one or more browser(s) (not shown in FIG. 1); a transaction management system 103; and a communication network 105. The computer network system 100 further includes at least one service provider device(s) 107, which can be operatively coupled to one or more compute device(s) 101a-101n, transaction management system 103, and/or other service provider device(s) 107 (not shown) via the communication network 105.

Communication network 105 can for example be any communication network, such as the Internet, configurable to allow the compute device(s) 101a-101n, the transaction management system 103, and the service provider device(s) 107 to communicate with communication network 105 and/or to each other through communication network 105. More specifically, communication network 105 can allow any of compute device(s) 101a-101n, the transaction management system 103, and the service provider device(s) 107 to communication with each other simultaneously. Communication network 105 can be any network or combination of networks capable of transmitting information (e.g., data and/or signals) and can include, for example, a telephone network, an Ethernet network, a fiber-optic network, a wireless network, and/or a cellular network. Furthermore, communication network 105 is, for example, capable of sending and/or identifying geo-location information (e.g., latitude and longitude coordinates) for devices connected to communication network 105 such as any of compute device(s) 101a-101n and the service provider device(s) 107. As discussed further below, in some instances, transaction management system 103 can be associated with a payer account accessed at a service provider device 107 and associated with a payee account accessed at compute device 101. In such instances, the geo-location information of both the service provider device 107 and the compute device 101 can be communicated through communication network 105.

In some instances, communication network 105 can include multiple networks operatively coupled to one another by, for example, network bridges, routers, switches and/or gateways. For example, the compute device(s) 101a-101n can be operatively coupled to a cellular network; and the service provider device(s) 107, and the transaction management system 103 can be operatively coupled to a fiber-optic network. The cellular network and fiber-optic network can each be operatively coupled to one another via one or more network bridges, routers, switches, and/or gateways such that the cellular network and the fiber-optic network are operatively coupled to collectively form a communication network.

Alternatively, the cellular network and the fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communication network.

As illustrated in FIG. 1, the compute device(s) 101a-101n is operatively coupled to communication network 105 via network connection(s) 109; service provider device(s) 107 is operatively coupled to communication network 105 via network connection(s) 111; and the transaction management system 103 is operatively coupled to communication network 105 via network connection(s) 113. Network connections 109, 111, and 113 can be any appropriate network connection for operatively coupling compute device(s) 101a-101n, service provider device(s) 107, and the transaction management system 103.

For example, one or more of network connections 109, 111, and 113 each can be a wireless network connection such as, for example, a wireless fidelity (“Wi-Fi”), a wireless local area network (“WLAN”) connection, a wireless wide area network (“WWAN”) connection, and/or a cellular connection. Alternatively, one or more of network connections 109, 111, and 113 each can be a wired connection such as, for example, an Ethernet connection, a digital subscription line (“DSL”) connection, a broadband coaxial connection, and/or a fiber-optic connection.

As mentioned above, in some instances, a computer network system 100 can include more than one compute device 101a-101n, more than one transaction management system 103, and more than one service provider device(s) 107. A compute device 101a-101n, a transaction management system 103, and/or a service provider device(s) 107, can be operatively coupled to the communication network 105 by heterogeneous network connections. For example, a first compute device 101a-101n can be operatively coupled to the communication network 105 by a WWAN network connection, another compute device 101a-101n can be operatively coupled to the communication network 105 by a DSL network connection, and a transaction management system 103 can be operatively coupled to the communication network 105 by a fiber-optic network connection. The service provider device(s) 107 can be, for example, a web server configured to provide various applications to electronic devices, such as compute device(s) 101a-101n.

The compute device(s) 101a-101n can be any of a variety of electronic devices that can be operatively coupled to communication network 105. A compute device(s) 101a-101n can be for example a personal computer, a tablet computer, a personal digital assistant (PDA), a cellular telephone, a smart phone, a TV, a portable/mobile Internet device and/or some other electronic communication device. The compute device(s) 101a-101n can each include one or more web browser(s) (not shown in FIG. 1) configured to access a webpage or website location hosted on or accessible via the service provider device(s) 107 over communication network 105. In addition or alternatively, the compute device(s) 101a-101n can include a geolocation functionality that provides signals or indications of the location of the compute device 101a-101n to communication network 105 and/or transaction management system 103. In such instances, the signals or indications of the location of the compute device(s) 101a-101n can be used by the transaction management system 103 to determine when the compute device(s) 101a-101n (and the user) is located near or within, for example, a particular location such as a targeted region.

The compute device(s) 101a-101n can be configured to support, for example, HyperText Markup Language (HTML) using JavaScript. The compute device(s) 101a-101n can include a web browser such as, for example, Internet Explorer®, Firefox®, Safari®, Dolphin®, Opera® and Chrome®. An Internet page, webpage, website location, an online video, a software application, etc. can be accessed by a user of a browser at a compute device 101a-101n by providing the browser with a reference such as a Uniform Resource Locator (URL), for example, of a webpage. In some instances, compute device(s) 101a-101n can include specialized software for accessing a web server other than a browser, such as, for example, a specialized network-enabled application or program. In some instances, portions of a website location accessible via a web server can be located in a local or remote memory space/data store accessible to the web server. The portions of the website location can be stored in the memory/data store in a database, a data warehouse, a file, etc. A compute device(s) 101a-101n can also include a display, monitor or user interface (not shown in FIG. 1), a keyboard, various communication or input/output (I/O) ports (e.g., a USB port), and other user interface features, such as, for example, digital pens, mice, touch screen controls, audio components, and/or video components (each not shown). A compute device(s) 101a-101n can be operatively coupled to communication network 105 via a user interface and a network connection 109.

A service provider device 107 can be a server that can execute a sales campaign(s) and/or on-line store(s). The service provider device 107 can provide communication between manufacturers or sellers (not shown in FIG. 1) and users of compute devices 101a-101n, for example, by executing the software that implements the sale campaign(s) or online store(s).

The transaction management system 103 can collect data associated with events related to online purchases initiated by users of compute device(s) 101a-101n such as, for example, payment transactions. The transaction management system 103 can use that data to define tokens before use in a transaction and associate the pre-defined tokens with transactions. Note that the transaction management system 103 or some of its components can be embedded within the service provider device(s) 107, within the compute devices 101a-101n, or be external to the service provider device(s) 107 and compute device(s) 101a-101n, and operatively coupled to one or more compute device(s) 101a-101n and one or more service provider device(s) 107 via the communication network 105.

Any of the devices or platforms of the computer network system 100 can include local memory/storage spaces (not shown in FIG. 1). Furthermore, the devices and platforms of the computer network system 100 can have access to centralized or distributed memory/storage spaces (not shown in FIG. 1), for example, through the communication network 105. Additionally, a compute device 101a-101n, a transaction management system 103, and a service provider device(s) 107, each can include one or more processors, performing processes and methods associated with the token management system described herein. Thus, FIG. 1 is merely an example illustrating the types of devices and platforms that can be included within a computer network system 100.

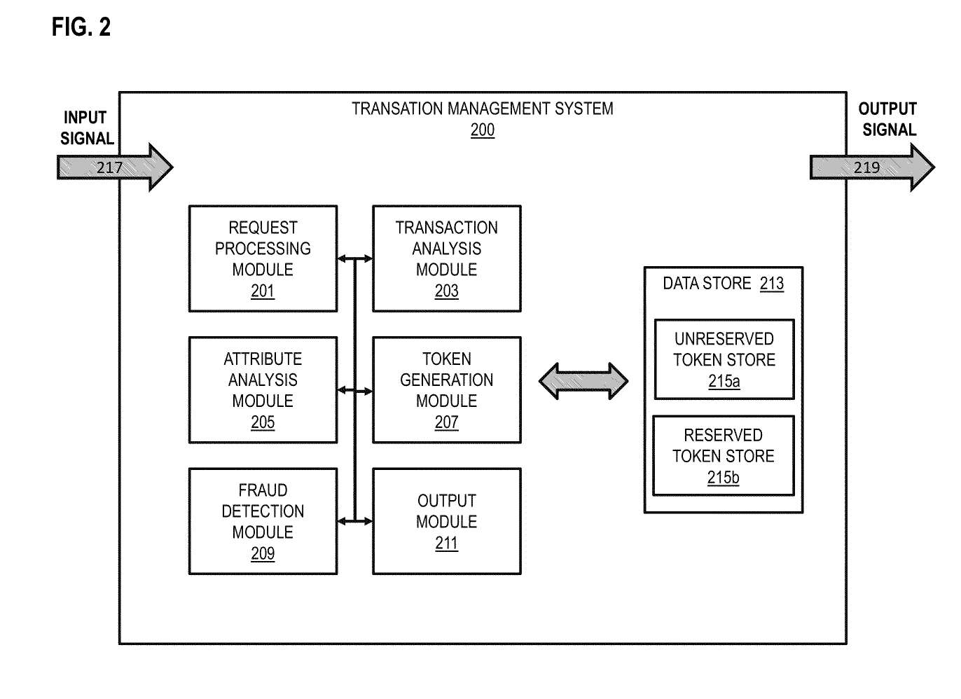

FIG. 2 is a schematic illustration of a transaction management system, according to an embodiment. Transaction management system 200 can be similar to the transaction management system 103 of FIG. 1. As shown in FIG. 2, a transaction management system 200 can include a request processing module 201, a transaction analysis module 203, an attribute analysis module 205, a token generation module 207, a fraud detection module 209, an output module 211, and a data store 213. The data store 213 can include an unreserved token store 215a and a reserved token store 215b. In various instances, the transaction management system 200 and its components can be located anywhere within a communication network system 100 such as that shown in FIG. 1 including, but not limited to, within the service provider device(s) 107, with the compute devices 101a-101n, or in separate network locations within the communication network system 100 of FIG. 1. Furthermore, the transaction management system 200 can communicate with other components of a network system 100 via input signal(s) 217 and output signal(s) 219.

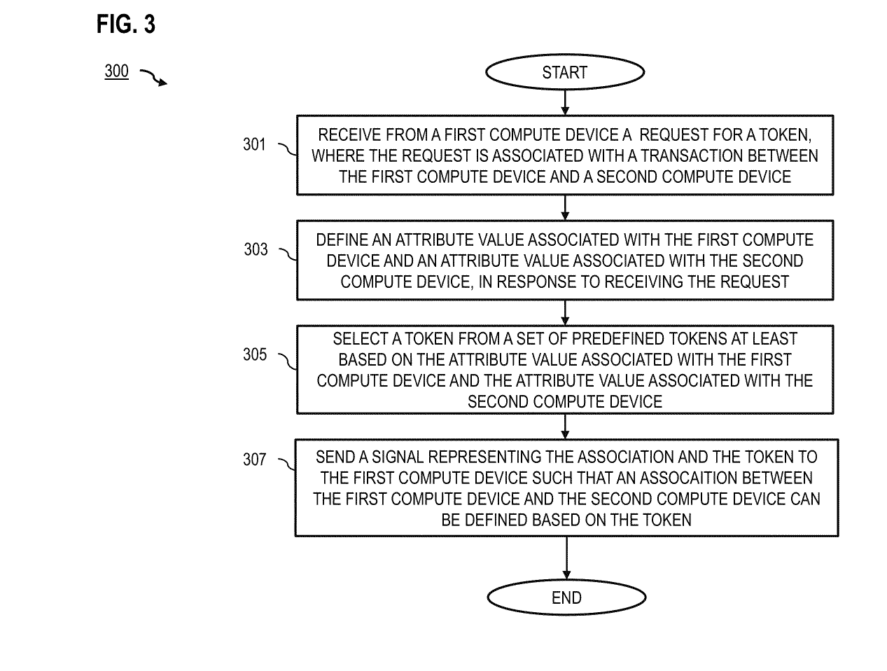

As used herein, a module can be, for example, any assembly and/or set of operatively-coupled electrical components, and can include, for example, a memory, a processor, electrical traces, optical connectors, software (stored in memory, or executing or to be executed in hardware) and/or the like. Furthermore, a module can be capable of performing one or more specific functions associated with the module, as discussed further below. The various modules of transaction management system 200 are discussed generally in connection with FIG. 2 and the overall discussion of transaction management system 200, and discussed more individually in connection with FIGS. 3 and/or 4 below.

The transaction management system 200 can provide transaction management for transactions between compute devices 101a-101n and service provider devices 107, of FIG. 1. In some embodiments, the transaction management system 200 can divide geographical locations into multiple regions such as, for example, targeted regions and untargeted regions. An untargeted region is defined as a region for which no historical data associated with transactions within that geographic region is available to the transaction management system. For example, an untargeted region can be a geographic region for which tokens have not been requested, including tokens in the unreserved token stored 215a and excluding tokens in the reserved token store 215b in data store 213. A targeted region is defined as a geographic region for which at least one token has been requested by a compute device 101a-101n while physically located in that region and associated with that region by the transaction management system 200. Targeted regions typically include regions that represent high usage of tokens, large numbers of applicable locations for token selection and high population, while untargeted regions typically include regions with lower population and no applicable geographic locations for which token selection has been yet made.

The transaction management system 200 can define a list of reserved tokens and associate the list of reserved tokens to one or more particular geographic regions. The list can be stored in reserved token store 215b. In such embodiments, when a token request is received from a compute device 101a-101n physically located in the one or more geographic regions, the transaction management system 200 can search the list of reserved tokens in reserved token store 215b associated with that particular geographic region for an unused token, and not search tokens, associated by other geographic regions. In other words, when a token request is received from a compute device 101a-101n physically located within a targeted region, the transaction management system 200 searches (in reserved token store 215b) the list of reserved tokens associated with that targeted region, but not reserved token associated with different targeted regions. If no tokens are available for that targeted region, then the transaction management system 200 can optionally search (in unreserved token store 215a) the list of unreserved tokens or the transaction management system 200 can deny a token to the requesting compute device 101a-101n. In this manner, the total number of tokens assigned for a given targeted region can be expanded in some instances or can be limited or capped in other instances.

When a reserved token 215b is selected for a geographic region different from the geographic region with which the reserved token is associated, the fraud detection module 209 can activate a security flag and prompt other modules of the transaction management system 200 and the service provider device 107 of a possible misuse of the tokens or an evidence of a malware. The transaction management system 200 can handle or manage the security of transactions based on the security flag. For example, the transaction management system 200 can implement different processes when the security flag is activated.

In some instances, the transaction management system 200 can associate a predefined threshold with a number of reserved tokens in reserved token store 215b that can be selected for each targeted geographic region. In such instances, if the number of tokens selected for a targeted geographic region exceeds the predefined threshold, the fraud detection module 209 can activate the security flag for possible fraudulent activity. The fraud detection module 209 can also prompt the service provider device (e.g., service provider device 107 in FIG. 1) of a new potential market that was previously unknown to the transaction management system 200 or an unpredicted growth of a previously-existing market with a higher volume of transaction demand. Upon receiving a prompt signal from the transaction management system 200, the service provider device can determine whether a new potential market has been identified by further analysis of activities and/or transactions within that geographic region.

In some instances, upon receiving a token request, the transaction management system 200 can check whether a payer's account is assigned to a particular geographical region. In that case, the transaction management system 200 can search for and retrieve an unused token from the reserved token store 215b for the current geographic region for the user. The output module 211 can then send the retrieved token back to the payer's device (e.g., a compute device 101a-101n) via an output signal 219.

The transaction management system 200 can define and store a list of unreserved tokens in unreserved token store 215a. When a token request is received from a compute device 101a-101n physically located in an untargeted region via an input signal 217, the transaction management system 200 can search the unreserved token store 215a for an unused token, and the output module 211 can send the unused token from the unreserved token store 215a to the compute device 101a-101n via an output signal 219.

As discussed above, in some instances, when compute devices 101a-101n physically located in and associated with a given targeted region request more tokens than the predefined threshold for the targeted region, the token generation module 207 can optionally use the unreserved token store 215a to overcome the overage to prevent token conflict among various regions. In other words, the token generation module 207 can reassign token(s) from the unreserved token store 215a to the reserved token store 215b for that geographic region. The number of reassigned tokens can be high enough to exceed the predefined number of available tokens for that geographic region. When reassigned, those tokens can be deleted from the unreserved token store 215a. Alternatively, token can be denied to the requesting compute device 101a-101n. In such an instance, token generation module 207 can trigger the sending of a deny signal to the requesting compute device 101a-101n and termination of the transaction. When such a denial occurs, the compute device 101a-101n can try to reinitiate the transaction and another token request can be generated later for when a token for the targeted region may be available.

FIG. 3 is a flowchart of a process for token definition, according to an embodiment. At 301, a request processing module (e.g., the request processing module 201 of the transaction management system 200 of FIG. 2) receives a request for a token from a compute device (e.g., 101a-101n in FIG. 1) via an input signal (e.g., input signal 217). The request is associated with a transaction to be conducted or attempted to be conducted between the compute device (e.g., compute device 101a-101n) and a service provider device (e.g., service provider device 107). In other words, the requested token is to be used to complete a transaction and will be associated with the transaction, for example, if the transaction is successful. The request processing module can store the request in a data store (e.g., data store 213).

At 303, the transaction analysis module (e.g., transaction analysis module 203) uses data included with the request to determine a type of the transaction. For example, the transaction analysis module 203 can define an attribute value associated with the compute device 101a-101n and an attribute value associated with the service provider device 107, based on the transaction type. For example, the attribute value(s) of a compute device 101a-101n can indicate a geographic location of that compute device and/or the operational characteristics of that compute device such as its operating system, an application used for the transaction, capabilities of the compute device, etc. Such attribute value(s) may be appropriate or defined as being needed for a particular transaction type (e.g., a purchase of an item in an on-line sale). The attribute value(s) of a service provider device can indicate transaction information specific to that service provider device. For other examples, the attribute value(s) for the compute device and/or service provider device can indicate a characteristic such as ownership of that device, user type, device type, network type used by that device, etc.

At 305, the attribute analysis module (e.g., attribute analysis module 205 of FIG. 2) analyzes the attributes and determines a token type to be selected for use in the transaction. For example, the attribute value can indicate a location of the compute device 101a-101n. For another example, the token type may indicate a reserved token or an unreserved token to be associated with the transaction. The token generation module (e.g., token generation module 207 of FIG. 2) can then select a token from a set of predefined tokens (for example, reserved token store 215b or unreserved token store 215a) corresponding to the determined token type. For example, the token generation module can randomly select a token from the set of predefined tokens for the determined token type. In some instances, the set of predefined tokens is selected from multiple sets of predefined tokens. Each set of predefined tokens from the sets of predefined tokens is associated with the attribute value associated with the compute device 101a-101n and the attribute value associated with the service provider device 107.

At 307, a transaction management system (e.g., transaction management system 200) sends a signal to the compute device (e.g., compute device 101a-101n) via an output signal (e.g., output signal 219), representing the token such that an association between the first compute device and the second compute device can be defined based on the token. The output signal can be sent such that the compute device can take another step in the transaction or complete the transaction based on the association and the token represented by the output signal.

Once the token has been defined, an association between the compute device (e.g., compute device 101a-101n) and the service provider device (e.g., service provider device 107) can be defined based on the token. For example, the association can be defined locally (e.g., at token generation module 207) or remotely once the token is received from the transaction management system 200. The association can be, for example, information about the transaction and/or information about the relationship between the compute device and the service provider device in the context of the transaction. For example, the association can represent a payment association from the compute device to the service provider device. In addition or alternatively, the association can represent a sale of a good(s) or service(s) provided by the service provider device to the compute device. Such good(s) or service(s) can be delivered and used by the compute device (e.g., software application, software upgrade, storage access remotely accessible by the compute device, etc.) or delivered to a user of the compute device for use independent of the compute device (e.g., book, DVD, cookware, etc.). Said another way, the token can be a payment token, the compute device 101a-101n can be a device used by a payer in a transaction and the service provider device 107 can be a device used by a payee of the transaction. In this example, the association between the compute device 101a-101n and the service provider device 107 can be a payment association between the payer device and the payee device.

In some instances, a transaction can involve multiple payer devices. For example, multiple compute devices 101a-101n can initiate a transaction with a service provider device 107. For example, n customers C₁, C₂, . . . , Cₙ can be payers in a transaction where each customer Cᵢ can choose to pay a portion xᵢ of a total payment amount X where X=x₁+x₂+ . . . +xₙ. Note that each token t can have one of four possible states as “unused”, “generated”, “used”, or “expired” at any given time. In the “unused” state, the token t being requested by a compute device 101a-101n is not associated with the compute device and therefore, the compute device 101a-101n cannot use token t for a valid transaction. In the “generated” state, the token t is associated with a tuple (X, R, L, B), where X is the amount to be paid, R is a geographical region, L is an expiration limit, and B identifies a service provider device 107 associated with the transaction. Such a token t can be used by the compute device 101a-101n for a transaction until limit L is reached or until a signal is received from the service provider device 107 identified as B to cancel token t prior to time limit L, when the token state is set to “expired”. In this state, each customer Cᵢ can request token t using a compute device 101a-101n and choose to pay an amount xᵢ<=X. A token t is in a “used” state, when t is associated with a transaction. Used tokens are not associated with any other transactions.

In instances where multiple payers are included in a transaction, the transaction management system 200 can receive, from each compute device 101a-101n associated with a given payer, a request for a token associated with the transaction between that compute device 101a-101n and the service provider device 107 (e.g., payee device). In such instances, the transaction analysis module 203 can define a transaction value associated with the service provider device 107. The transaction management system 200 (or a different system that receives the generated token) can receive a signal representing a payment value from each of the compute devices 101a-101n. The transaction analysis module 203 can define a total payment value based on the payment value for each compute device 101a-101n. If the total payment value is equal to the transaction value, the transaction management system 200 can send a signal to each compute device 101a-101, via an output signal 219, to allow the transaction. Otherwise, if the total payment value is not equal to the transaction value, the transaction management system 200 can send a signal to each compute device 101a-101n to disallow the transaction.

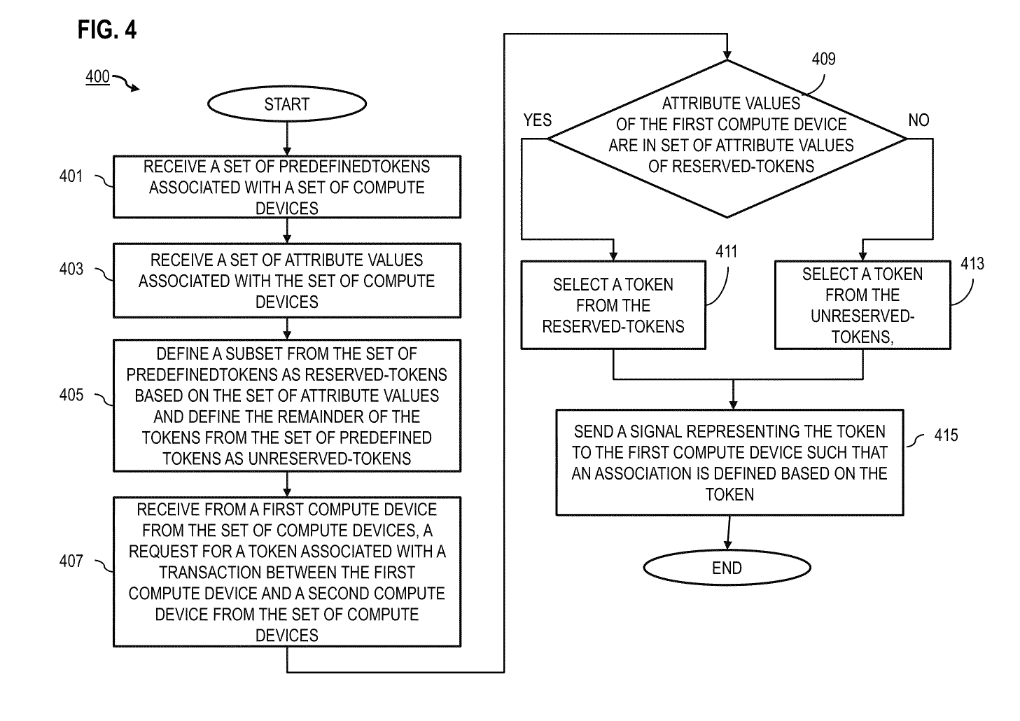

FIG. 4 is a flowchart of a process for token definition based on token reservation, according to an embodiment. At 401, the token generation module (e.g., token generation module 207 of FIG. 2) receives a set of predefined tokens associated with a set of devices. The set of devices may include compute devices 101a-101n, service provider device(s) 107, etc. In some instances, the list of predefined tokens can be previously defined by the token generation module and stored in data store (e.g., data store 213 of FIG. 2). In other instances, the set of predefined tokens can be provided by one or more devices from the set of devices. The token generation module can store the set of predefined tokens in data store.

At 403, the attribute analysis module (e.g., attribute analysis module 205 of FIG. 2) receives a set of attribute values associated with the set of devices. The attribute values can define various characteristics associated with the devices such as for example, location, ownership, user type, device type, network type, etc. The attribute analysis module can store the set of attribute values in data store.

At 405, the token generation module (e.g., token generation module 207 at FIG. 2) can define a subset from the set of predefined tokens as reserved tokens in the reserved token store (e.g., reserved token store 215b of FIG. 2) based on the set of attribute values and define the remainder of the tokens from the set of predefined tokens as unreserved tokens in unreserved token store (e.g., reserved token store 215a). For example, the token generation module 207 can define a subset of predefined tokens reserved for an attribute value A1 (e.g., A1 can be a geographic region).

At 407, the request processing module (e.g., request processing module 201 of FIG. 2) receives, from a compute device from the set of devices, a request for a token associated with a transaction between the compute device and a service provider device from the set of devices.

At 409, the attribute analysis module analyses attribute values associated with the compute device. For example, the attribute analysis module 205 can send a request to the token generation module 207 for a set of predefined tokens associated with the compute device 101a and the service provider device 107 based on the attribute values. If the type of tokens associated with the attribute values is reserved token, at 411, the token generation module selects a token from the set of reserved tokens in reserved token store to be associated with the transaction. Otherwise, if the attribute value is not associated with a reserved token type, the token generation module at 413, selects a token from the unreserved token store to be associated with the transaction.

At 415, the transaction management system sends a signal via an output signal, representing the association and the token to the compute device such that an association between the first compute device and the second compute device can be defined based on the token.

In some instances, the token generation module 207 can receive the set of predefined tokens and the set of attribute values, for example from data store 213. The token generation module 207 can define a subset from the set of predefined tokens as the reserved tokens based on the set of attribute values and store the reserved tokens in reserved token store 215b. The token generation module 207 can also define the remainder of the tokens from the set of predefined tokens as the unreserved tokens and store the unreserved tokens in unreserved token store 215a.

In some embodiments, transaction management system 200 defines, for the compute device(s) 101a-101n, a frequency at which tokens from the unreserved token store 215a are selected. The frequency can be defined based on the request data received from the compute device(s) 101a-101n by the request processing module 201. The fraud detection module 209 can check whether the frequency exceeds a predefined threshold. The predefined threshold can be defined by the service provider device 107 and stored in data store 213. When the frequency exceeds the predefined threshold, the output module 211 can send a signal to the service provider device 107 via an output signal 219 setting a security flag and indicating a fraudulent activity.

In some instances, the token generation module 207 can assign a portion of the reserved tokens in the reserved token store 215b to a subset of the set of compute devices 101a-101n based on the attribute values associated with the subset of the set of compute devices 101a-101n. In such instances, when selecting a token from the reserved token store 215b for a compute device 101a-101n from the subset, the token generation module 207 can select the token from the assigned portion of the reserved tokens.

In some instances, the token generation module 207 can define, for the compute device(s) 101a-101n, an upper limit of a number of tokens that can be selected from the reserved tokens for the compute device(s). The upper limit can be determined by the service provider device 107 and sent to the transaction management system 200 via the communication network 105. The token generation module 207 can receive the upper limit via the input signal 217 and define the predetermined limit based on the upper limit. In such instances, when the attribute values associated with the compute device 101a-101n are included in the set of attribute values associated with the reserved tokens of the reserved token store 215b, but the frequency exceeds the predetermined limit/upper limit, the token generation module 207 selects a token from the unreserved token store 215a.

In some instances, each compute device 101a-101n can be associated with a region value from a set of region values. Each region value from the set of region values can be associated with a flag value as targeted or untargeted. The set of compute devices 101a-101n can be associated with a set of predefined tokens such that the set of predefined tokens has a subset of predefined tokens defined as reserved tokens (e.g., tokens in reserved token store 215b) where the reserved tokens are defined based on the set of region values. For example, a region can be associated with a subset of reserved tokens from the reserved token store 215b. The remainder of tokens from the set of predefined tokens can be defined as unreserved tokens (e.g., tokens in unreserved token store 215a). In such instances, when the flag value for the region value associated with the compute device 101a-101n is targeted, the token generation module 207 selects a token from the reserved token store 215b, and when the flag value for the region value associated with the compute device 101a-101n is untargeted, the token generation module 207 selects a token from the unreserved token store 215a.

In some instances, the transaction analysis module 203 receives, for each region value from the set of region values, a token usage data for that region value. The transaction analysis module 203 can receive the token usage data from the token generation module 207 or from data store 213. The transaction analysis module 203 can also receive, for each region value from the set of region values, a population data associated for that region value. The transaction analysis module 203 can receive the population data from the service provider device 107 via an input signal 217. The transaction analysis module 203 can further receive, for each region value from the set of region values, a token generation location data for that region value. The token generation location data can be received from the token generation module 207. The transaction analysis module 203 can define the flag value for each region value from the set of region values based on the token usage data for that region value, the population data for that region value and the token generation location data for that region value. The transaction analysis module 203 can store the flag value at data store 213.

In some instances, the fraud detection module 209 can receive, for the compute device 101a-101n, an indicator of a token used by that compute device for the association between that compute device and the service provider device 107. The fraud detection module 209 can receive a token usage indicator from the token generation module 207. If the token indicator shows that the token used by the compute device 101a-101n is from the assigned subset of the reserved tokens to another compute device 101a-101n, the output module 211 sends a signal indicating a fraudulent activity to the service provider device 107, via an output signal 219.

In some instances, if a value of usage data associated with use of tokens within a geographic region is higher than a predefined threshold (for example, defined by the service provider device 107), this can indicate an increase in demand in that geographic region. In such instances, if the geographic region is an untargeted geographic region, the transaction analysis module 203 can update the flag value for that geographic region from untargeted to targeted. This can prompt the token generation module 207 to define and associate reserved tokens from the reserved token store 215b to that geographic region.

In some instances, if a value of the usage data associated with a geographic region is lower than a predefined threshold (for example, defined by the service provider device 107), this can indicate a decrease in demand in that geographic region. In such instances, if the geographic region is a targeted region and associated with reserved tokens, the transaction analysis module 203 can update the flag value for that region from targeted to untargeted. This can prompt the token generation module 207 to define unreserved tokens from the unreserved token store 215a for that geographic region when requested.

In some instances, if a value of the population data associated with a geographic region is higher than a predefined threshold (for example, defined by the service provider device 107), this can indicate a high in demand in that geographic region. In such instances, if the geographic region is an untargeted region, the transaction analysis module 203 can update the flag value for that geographic region from untargeted to untargeted. This can prompt the token generation module 207 to define and associate reserved tokens from the reserved token store 215b to that region.

In some instances, if a value of the population data associated with that geographic region value is lower than the predefined threshold (for example, defined by the service provider device 107), this can indicate a low demand in that geographic region. In such instances, if the geographic region is a targeted region and associated with reserved tokens, the transaction analysis module 203 can update the flag value for that geographic region from targeted to untargeted. This can prompt the token generation module 207 to define unreserved tokens from the unreserved token store 215a for that geographic region when requested.

It is intended that the methods and apparatus described herein can be performed by software (stored in memory, or executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, PHP, Python, Ruby, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein.

1.-3. (canceled)

4. The non-transitory processor-readable medium of claim 14, wherein the first compute device is a first payer device from a plurality of payer devices, the second compute device is a payee device, and the transaction is a payment associated with the plurality of payer devices and the payee device, the code further comprising code to cause the processor to:
receive, from each payer device from the plurality of payer devices, a request for a token associated with a payment associated with that payer device and the payee device;
define a transaction value associated with the payee device;
receive a plurality of payment values, each payment value from the plurality of payment values being associated with a payer device from the plurality of payer devices;
define a total payment value based on the plurality of payment values;
send a signal to each payer device from the plurality of payer devices to allow the transaction, if the total payment value is equal to the transaction value; and
send a signal to each payer device from the plurality of payer devices to disallow the transaction, if the total payment value is not equal to the transaction value.

5. (canceled)

6. The non-transitory processor-readable medium of claim 14, wherein each token from the set of predefined tokens has a token-state, the selected token has a generated token state at a first time and an expiration limit, the code further comprising code to cause the processor to:
update the token-state of the selected token to an expired token state at a second time after the first time, the second time occurring being one of (1) when the expiration limit is reached or (2) when a signal is received from the second compute device indicating that the token state of the token should be set to the expired token state.

7. The non-transitory processor-readable medium of claim 14, wherein:
each token from the set of predefined tokens has a token-state, and
the selected token has an unused token state at a first time,
the code to cause the processor to select the reserved token includes code to cause the processor to select the reserved token at a second time after the first time, the code further comprising code to cause the processor to:
update the token state of the selected token to a used token state in response to the selection of the token.

8. (canceled)

9. The non-transitory processor-readable medium of claim 14, the code further comprising code to cause the processor to:
receive the set of predefined tokens associated with the set of compute devices;
receive an indication of an attribute for each compute device from the set of compute devices; and
define the plurality of sets of reserved tokens from the set of predefined tokens based on the indications of attributes for the set of compute devices.

10. The non-transitory processor-readable medium of claim 14, the code further comprising code to cause the processor to:
calculate, for the first compute device, a frequency at which tokens from the unreserved tokens are selected;
send a signal indicating a fraudulent activity to the second compute device, when the frequency exceeds a predefined threshold.

11.-12. (canceled)

13. The non-transitory processor-readable medium of claim 14, the code further comprising code to cause the processor to:
calculate, for the first compute device, a frequency at which tokens from the reserved tokens are selected to produce a calculated frequency;
define, for the first compute device, an upper frequency limit associated with selection of tokens from the reserved tokens;
the code to cause the processor to select the token from the reserved tokens further includes code to cause the processor to select the token from the reserved tokens when the calculated frequency is below the upper frequency limit; and
the code to cause the processor to select the unreserved token further includes code to cause the processor to select the unreserved token when the attribute associated with the first compute device matches an attribute associated with any set of reserved tokens and the calculated frequency exceeds the upper frequency limit.

14. A non-transitory processor-readable medium storing code representing instructions to be executed by a processor, the code comprising code to cause the processor to:
receive, for each geographic region from a set of geographic regions, token usage data;
receive, for each geographic region from the set of geographic regions, population data;
receive, for each geographic region from the set of geographic regions, token generation location data;
set, for each token from a set of predefined tokens, one of a targeted flag or an untargeted flag, each token from the set of predefined tokens having a region value associated with a geographic region from the set of geographic regions the targeted flag or the untargeted flag set based on (1) the region value for that token, (2) the token usage data for the geographic region associated with that region value, (3) the population data for the geographic region associated with that region value, and (4) the token generation location data for the geographic region associated with that region value;
receive, from a first compute device, a request for a token associated with a transaction between the first compute device and a second compute device,
the first compute device associated with a first geographic region from a set of geographic regions, one of (1) the targeted flag or (2) the untargeted flag associated with the first geographic region,
the request for the token being a request for a token from a set of predefined tokens, the set of predefined tokens including a reserved token and an unreserved token;
select the reserved token when the geographic region is associated with the targeted flag;
select the unreserved token when the geographic region is associated with the untargeted flag; and
send a signal representing the selected token to the first compute device such that the first compute device completes the transaction using the selected token.

15. The non-transitory processor-readable medium of claim 14, the code further comprising code to cause the processor to:
receive the set of predefined tokens, the reserved token being a first reserved token having a first region value, the set of predefined tokens including a second reserved token having a second region value; and
set, for each of the first reserved token and the second reserved token, one of the targeted flag or the untargeted flag.

16. (canceled)

17. The non-transitory processor-readable medium of claim 14, wherein the first compute device is from a set of compute devices, each compute device from the set of compute devices is associated with a geographic region from the set of geographic regions, and the reserved token is from a set of reserved tokens, the code further comprising code to cause the processor to:
assign, for each compute device from the set of compute devices associated with a geographic region that is associated with a targeted flag, a subset of the reserved tokens, the first compute device being associated with a geographic region that is associated with a targeted flag;
receive, an indicator of a token used by the first compute device, the token used by the first compute device being from a subset of reserved tokens assigned to a third compute device, the third compute device associated with a second geographic region different from the first geographic region; and
send a signal indicating a fraudulent activity to the second compute device based on the token used by the first compute device being from the subset of the reserved tokens assigned to the third compute device.

18. The non-transitory processor-readable medium of claim 14, the code further comprising code to cause the processor to:
receive, for a geographic region from the set of geographic regions, an updated token usage data, the updated token usage data being received after the token usage data is received, the updated token usage data being higher than the token usage data for that geographic region;
update the flag for each token from the set of predefined tokens associated with the geographic region for which the updated token usage data was received from untargeted to targeted based on the updated token usage data being higher than a predefined threshold.

19. The non-transitory processor-readable medium of claim 14, the code further comprising code to cause the processor to:
receive, for a geographic region from the set of geographic regions, an updated population data, the updated population data being received after the population data is received, the updated population data being higher than the population data for that geographic region;
update the flag value for each token from the set of predefined tokens associated with the geographic region for which the updated population data was received from untargeted to targeted based on the updated population data being higher than a predefined threshold.
